(19) United States
(12) Patent Application Publication
(10) Pub. No.: US 2015/0064294 A1
(43) Pub. Date: Mar. 5, 2015

(54) Release Device Applied in Electronic Package

(71) Applicant: SureGiant Technology Co., Ltd, Luzhu/Taoyuan (TW)

(72) Inventor: Yun-Pin Yang, Luzhu/Taoyuan (TW)

(73) Assignee: SureGiant Technology Co., Ltd, Luzhu/Taoyuan (TW)

(21) Appl. No.: 14/010,521

(22) Filed: Aug. 27, 2013

(51) Int. Cl. B29C 33/60

(52) U.S. Cl. CPC B29C 33/60; B29K 2901/12
USPC 425/89

(57) ABSTRACT

The present invention relates to a release device applied in electronic package, wherein the release device is attached to the inner surface of a transfer modeling mold for electronic package. In the present invention, the release device consists of a substrate and a release layer formed on the substrate, wherein the substrate is made of a plastic material with the thickness of 0.016 mm˜0.5 mm, and the plastic material can be PET, PP, PC, PE, PI, or PVC. Differing from the substrate, the release layer is made of a pure silica gel or a silica gel/rubber compound with the thickness of 0.02 mm˜2 mm. The release device can provide a releasing force for facilitating the modeled device formed by using the transfer modeling mold be easily separated from the mold, and avoid part of manufacture material from remaining in the inner surface of the mold.

### BACKGROUND OF THE INVENTION

1. Field of the Invention

The present invention relates to transfer modeling technologies for electronic package, and more particularly to a release device applied in electronic package.

2. Description of the Prior Art

Currently, the primary process of thermosetting plastic is compression molding. When a compression molding process is executed, because the thermosetting plastic must be cooled for solidification, the modeled thermosetting plastic does usually be separated from the mold after the solidification is completed; for this reason, the production efficiency of the compression molding process is hard to be increased. Accordingly, a transfer modeling technology is proposed. Please refer to FIG. 1, there is shown a schematic diagram for the manufacturing process of the transfer modeling technology; as shown in FIG. 1, the manufacturing process of the transfer modeling technology includes the processing steps of:

(1) disposing a molding plastic material 11′ in a transfer modeling chamber 15′;

(2) putting a device to be modeled in a mold 14′, wherein the mold 14′ connects with the transfer modeling chamber 15′ via an injection channel 16′;

(3) heating the molding plastic material 11′ for liquefying the molding plastic material 11′ in the transfer modeling chamber 15′;

(4) filling a fluid plastic material 13′ into the heated mold 14′ through the injection channel 16′;

(5) cooling the mold 14′ for making the fluid plastic material 13′ solidify;

(6) opening the mold 14′, and separating the modeled device 60′ from the mold 14′;

(7) taking out the modeled device 60′;

(8) there are some solidified plastic material remaining in the transfer modeling chamber 15′ and the injection channel 16′, and these remained plastic material needs to be remove before the second manufacturing process of the transfer modeling technology is executed.

Usually, it needs to attach a release film onto the inner surface of the mold 14′ for facilitating the modeled device 60′ be easily separated from the mold 14′ in processing step (7). Accordingly, the inventor of the present application has made great efforts to make inventive research thereon and eventually provided release device applied in electronic package.

### SUMMARY OF THE INVENTION

The primary objective of the present invention is to provide a release device applied in electronic package, used for being attached to the inner surfaces of a transfer modeling mold when a transfer modeling electronic package is processed; therefore, the release device of the present invention can provide a releasing force for facilitating the modeled device formed by using the transfer modeling mold be easily separated from the mold, and avoid part of manufacture material from remaining in the inner surface of the mold.

Accordingly, to achieve the primary objective of the present invention, the inventors propose a release device applied in electronic package, which is used for being attached to the inner surface of a transfer modeling mold for electronic package, and comprises: a substrate, having a substrate thickness ranged from 16 μm to 500 μm; and a release layer, being formed on the substrate with a release layer thickness ranged from 20 μm to 2000 μm.

For the aforesaid release device applied in electronic package, the substrate is made of a plastic material selected from the group consisting of: PET, PP, PC, PE, PI, and PVC; moreover, the manufacture material of the release layer is selected from the group consisting of: pure silica gel and silica gel/rubber compound.

Furthermore, to achieve the primary objective of the present invention, the inventors propose a second embodiment of the release device applied in electronic package, wherein the second embodiment of the release device is a release layer having a release layer thickness ranged from 20 μm to 2000 μm, and the manufacture material of the release layer is selected from the group consisting of: pure silica gel and silica gel/rubber compound.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 is a schematic cross-sectional side view of a metallic glass film for medical application according to the present invention;

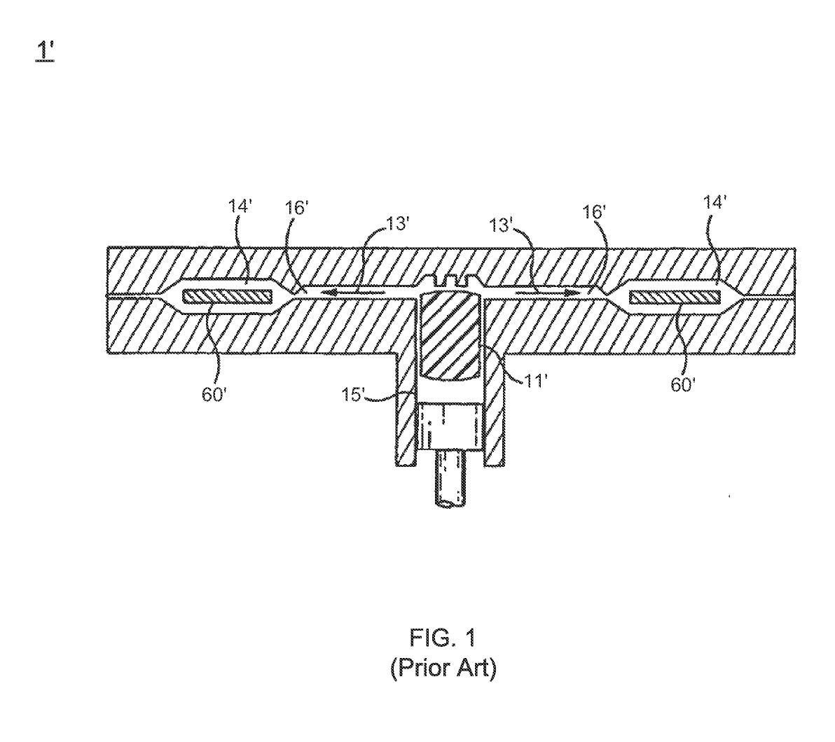

FIG. 2 is a schematic diagram for the manufacturing process of transfer modeling electronic package;

FIG. 3 is a side cross-sectional view of a release device applied in electronic package according to the present invention;

FIG. 4 is a side cross-sectional view of a second embodiment for the release device applied in electronic package according to the present invention.

### DETAILED DESCRIPTION OF THE PREFERRED EMBODIMENTS

To more clearly describe a release device applied in electronic package according to the present invention, embodiments of the present invention will be described in detail with reference to the attached drawings hereinafter.

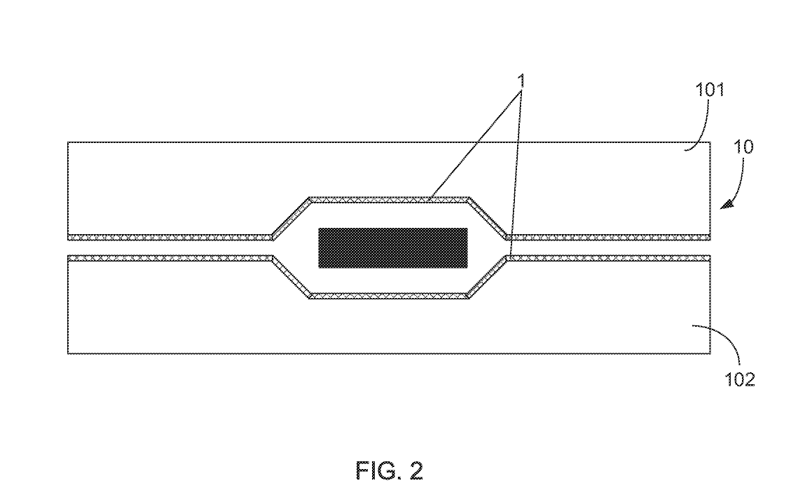

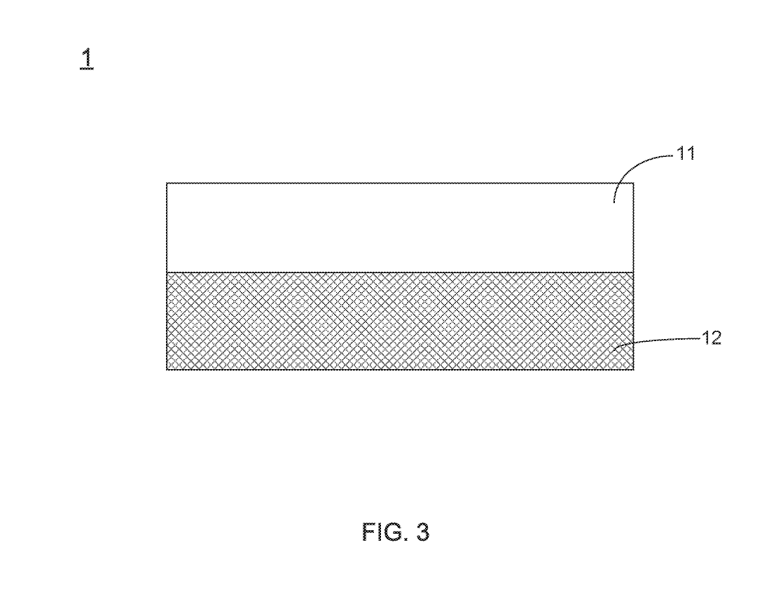

Please refer to FIG. 2, which illustrates a schematic diagram for the manufacturing process of transfer modeling electronic package; moreover, please simultaneously refer to FIG. 3, there is shown a side cross-sectional view of a release device applied in electronic package according to the present invention. As shown in FIG. 2 and FIG. 3, the release device 1 of the present invention is used for being attached to the inner surfaces of an upper mold 101 and a lower mold 102 of a transfer modeling mold 10 when the transfer modeling electronic package is processed, wherein the release device 1 consists of a substrate 11 and a release layer 12 formed on the substrate 11.

Particularly, in the present invention, the thickness of the substrate 11 is ranged from 16 μm to 500 μm, and the manufacture material of the substrate 11 can be PET, PP, PC, PE, PI, or PVC. Oppositely, the thickness of the release layer 12 is ranged from 20 μm to 2000 μm, and the manufacture material of the release layer 12 can be pure silica gel and silica gel/rubber compound. In the present invention, the said silica gel/rubber compound is consisted of a silica gel, a rubber and a plastic material, wherein the composition ratio of the silica gel in the silica gel/rubber compound is ranged from 100% to 5%, the composition ratio of the rubber in the silica gel/rubber compound is ranged from 0% to 90%, and the composition ratio of the plastic material in the silica gel/rubber compound is ranged from 0% to 5%. Therefore, the hardness of the release layer 12 is ranged from 1 to 80 according to the standard SHORE type A of ASTMD2240.

Herein, it needs to further explain that, the thickness of the substrate 11 is preferably ranged from 16 μm to 100 μm and the thickness of the release layer 12 is preferably ranged from 20 μm to 2000 μm in order to make the release device 1 proposed by the present invention performs a better hardness. Moreover, the preferable composition ratio of the silica gel in the silica gel/rubber compound is ranged from 80% to 50%, the preferable composition ratio of the rubber in the silica gel/rubber compound is ranged from 10% to 40%, and the preferable composition ratio of the plastic material in the silica gel/rubber compound is ranged from 0% to 10%. Therefore, the hardness of the release layer 12 is ranged from 30 to 60 according to the standard SHORE type A of ASTMD2240.

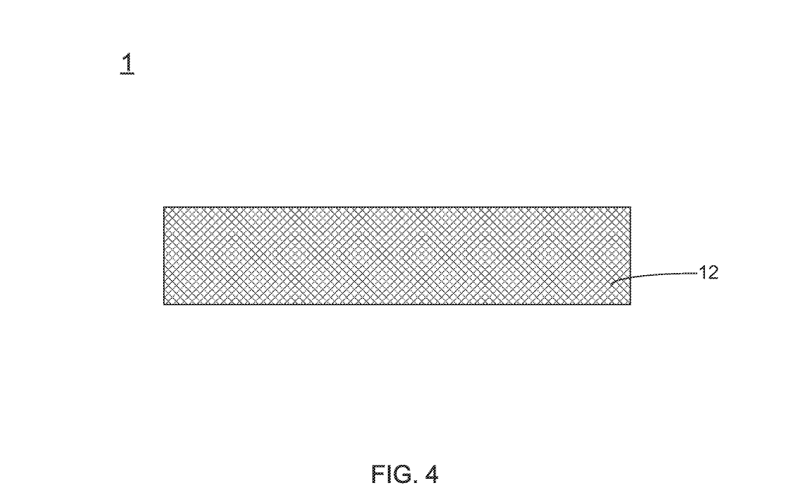

Thus, the above descriptions have been completely introduce the first embodiment of the release device 1 applied in electronic package according to the present invention; next, a second embodiment of the release device 1 applied in electronic package will be further introduced in following paragraph. Please refer to FIG. 4, there is shown a side cross-sectional view of the second embodiment for the release device applied in electronic package according to the present invention. As shown in FIG. 4, the second embodiment of the release device 1 is a release layer 12 having the thickness ranged from 20 μm to 2000 μm, and the manufacture material of the release layer 12 is selected from the group consisting of: pure silica gel and silica gel/rubber compound. In the present invention, the said silica gel/rubber compound is consisted of a silica gel, a rubber and a plastic material, wherein the composition ratio of the silica gel in the silica gel/rubber compound is ranged from 100% to 5%, the composition ratio of the rubber in the silica gel/rubber compound is ranged from 0% to 90%, and the composition ratio of the plastic material in the silica gel/rubber compound is ranged from 0% to 5%. Therefore, the hardness of the release layer 12 is ranged from 1 to 80 according to the standard SHORE type A of ASTMD2240.

Furthermore, for making the release device 1 proposed by the present invention performs a better hardness, the preferable composition ratio of the silica gel in the silica gel/rubber compound is ranged from 80% to 50%, the preferable composition ratio of the rubber in the silica gel/rubber compound is ranged from 10% to 40%, and the preferable composition ratio of the plastic material in the silica gel/rubber compound is ranged from 0% to 10%. Therefore, the hardness of the release layer 12 is ranged from 30 to 60 according to the standard SHORE type A of ASTMD2240.

Thus, the above descriptions have been completely introduce the release device 1 applied in electronic package according to the present invention; in summary, the release device 1 of the present invention includes the advantages of: the release device 1 can be attached to the inner surfaces of the transfer modeling mold 10 when the transfer modeling electronic package is processed, so as to provide a releasing force for facilitating the modeled device formed by using the transfer modeling mold 10 be easily separated from the mold, and avoid part of manufacture material from remaining in the inner surface of the mold.

The above description is made on embodiments of the present invention. However, the embodiments are not intended to limit scope of the present invention, and all equivalent implementations or alterations within the spirit of the present invention still fall within the scope of the present invention.

What is claimed is:

1. A release device applied in electronic package, used for being attached to the inner surface of a transfer modeling mold for electronic package, wherein the release device comprises:
a substrate, having a substrate thickness ranged from 16 μm to 500 μm; and
a release layer, being formed on the substrate with a release layer thickness ranged from 20 μm to 2000 μm.

2. The release device applied in electronic package of claim 1, wherein the substrate is made of a plastic material selected from the group consisting of: PET, PP, PC, PE, PI, and PVC.

3. The release device applied in electronic package of claim 2, wherein the substrate thickness is preferably ranged from 16 μm to 100 μm, and the release layer thickness being preferably ranged from 20 μm to 2000 μm.

4. The release device applied in electronic package of claim 1, wherein the manufacture material of the release layer is selected from the group consisting of:
pure silica gel and silica gel/rubber compound.

5. The release device applied in electronic package of claim 4, wherein the aforesaid silica gel/rubber compound is consisted of a silica gel, a rubber and a plastic material, wherein the composition ratio of the silica gel in the silica gel/rubber compound is ranged from 100% to 5%, the composition ratio of the rubber in the silica gel/rubber compound is ranged from 0% to 90%, and the composition ratio of the plastic material in the silica gel/rubber compound is ranged from 0% to 5%.

6. The release device applied in electronic package of claim 1, wherein the hardness of the release layer is ranged from 1 to 80 according to the standard SHORE type A of ASTMD2240.

7. A release device applied in electronic package, used for being attached to the inner surface of a transfer modeling mold for electronic package, wherein the release device is a release layer having a release layer thickness ranged from 20 μm to 2000 μm, and the manufacture material of the release layer is selected from the group consisting of: pure silica gel and silica gel/rubber compound.

8. The release device applied in electronic package of claim 7, wherein the aforesaid silica gel/rubber compound is consisted of a silica gel, a rubber and a plastic material, wherein the composition ratio of the silica gel in the silica gel/rubber compound is ranged from 100% to 5%, the composition ratio of the rubber in the silica gel/rubber compound is ranged from 0% to 90%, and the composition ratio of the plastic material in the silica gel/rubber compound is ranged from 0% to 5%.

9. The release device applied in electronic package of claim 7, wherein the hardness of the release layer is ranged from 1 to 80 according to the standard SHORE type A of ASTMD2240.
